(19) United States
(12) Patent Application Publication
(10) Pub. No.: US 2018/0141450 A1
(43) Pub. Date: May 24, 2018

(54) VEHICLE BASED CHARGING STATION ROBOT ARM CONTROL

(71) Applicant: Faraday&Future Inc., Gardena, CA (US)

(72) Inventors: Sangmin Oh, Santa Clara, CA (US); Yong-Dian Jian, Campbell, CA (US); Kai Ni, Sammamish, CA (US)

(21) Appl. No.: 15/638,238

(22) Filed: Jun. 29, 2017

Related U.S. Application Data
(60) Provisional application No. 62/356,481, filed on Jun. 29, 2016.

(51) Int. Cl. B60L 11/18; B25J 9/16; B25J 19/02; G01S 17/06

(52) U.S. Cl. CPC B60L 11/1827; B60L 11/1816; B25J 9/1694; B25J 19/021; Y10S 901/47; B60L 2230/40; B60L 2240/72; Y10S 901/09; G01S 17/06

(57) ABSTRACT

A system that performs a method is disclosed. Whether a charging station is available to charge the vehicle is determined. In accordance with a determination that a charging station is available, one or more position parameters for a charging arm of the charging station are obtained using the one or more scanners. Based on the obtained one or more position parameters, one or more commands are generated to control the motion of the charging arm to couple the charging arm to the vehicle to charge the vehicle.

### CROSS-REFERENCE TO RELATED APPLICATIONS

This application claims the benefit of U.S. Provisional Application No. 62/356,481, filed Jun. 29, 2016, the entirety of which is hereby incorporated by reference.

### FIELD OF THE DISCLOSURE

This disclosure relates generally to vehicle charging and, more particularly, to a vehicle control system that controls the motion of a charging arm associated with a charging station.

### BACKGROUND OF THE DISCLOSURE

Deployment of self-driving automated systems in vehicles has rapidly increased in recent years. A vehicle may have batteries that need to be charged from time to time. Currently, to charge a vehicle, a user needs to manually pull the charging cable from a charging station, plug it into the vehicle, monitor the charging progress, unplug the charging cable from the vehicle when the charging is complete, and put the charging cable back on the charging station. Therefore, to reduce the cumbersomeness and user effort in the charging process, it can be beneficial to use on-vehicle scanners to facilitate automation of the charging process.

### SUMMARY OF THE DISCLOSURE

Examples of the disclosure are directed to a vehicle control system disposed or included in a vehicle. The system can include one or more processors, one or more scanners and one or more memories. In some examples, the system determines whether a charging station is available. In some examples, in accordance with a determination that a charging station is available, the system obtains one or more position parameters, using the one or more scanners disposed in the vehicle, for a charging arm of the charging station. In some examples, based on the obtained one or more position parameters, the system generates one or more commands to control the motion of the charging arm to couple the charging arm to the vehicle to charge the vehicle.

### BRIEF DESCRIPTION OF THE DRAWINGS

FIG. 1 illustrates an exemplary scenario in which a vehicle control system disposed in a vehicle determines whether a charging station is available according to examples of the disclosure.

FIG. 2 illustrates an exemplary scenario in which a vehicle control system disposed in a vehicle determines whether charging of the vehicle is to be initiated according to examples of the disclosure.

FIG. 3 illustrates an exemplary automated vehicle charging scenario in which a vehicle control system disposed in a vehicle generates commands to control the motion of the charging arm of a charging station according to examples of the disclosure.

FIG. 4 illustrates an exemplary process for automated vehicle charging according to examples of the disclosure.

FIG. 5 illustrates a system block diagram of a vehicle control system according to examples of the disclosure.

### DETAILED DESCRIPTION

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

Some vehicles may provide signals indicating a charging process has started, is ongoing, or is complete. For these vehicles, the charging process is still largely a manual process and the vehicles have almost no control over the charging process besides passively receiving electrical charges from the charging station. It is beneficial for vehicles to have control over the charging station to facilitate automated charging. A vehicle control system can utilize one or more scanners disposed in the vehicle and control a charging arm of a charging station to automatically couple to the vehicle to start charging. The vehicle control system can also decouple the charging arm of the charging station from the vehicle after the charging is complete. In some examples, the vehicle control system may not require user intervention or requires greatly reduced user intervention for charging the vehicle. Thus, it significantly reduces the burden or effort associated with charging a vehicle.

FIG. 1 illustrates an exemplary scenario in which a vehicle control system disposed in a vehicle determines whether a charging station is available according to examples of the disclosure. FIG. 1 shows a vehicle 110, a parking space 130, and a charging station 140. Vehicle 110 can be any type of vehicle, such as an automobile, a bus, a truck, a van, a motorcycle, etc. Vehicle 110 can include one or more chargeable batteries. In some examples, vehicle 110 can be an autonomous vehicle that does not require or requires reduced user intervention compared to a non-autonomous vehicle (e.g., a vehicle controlled by a human).

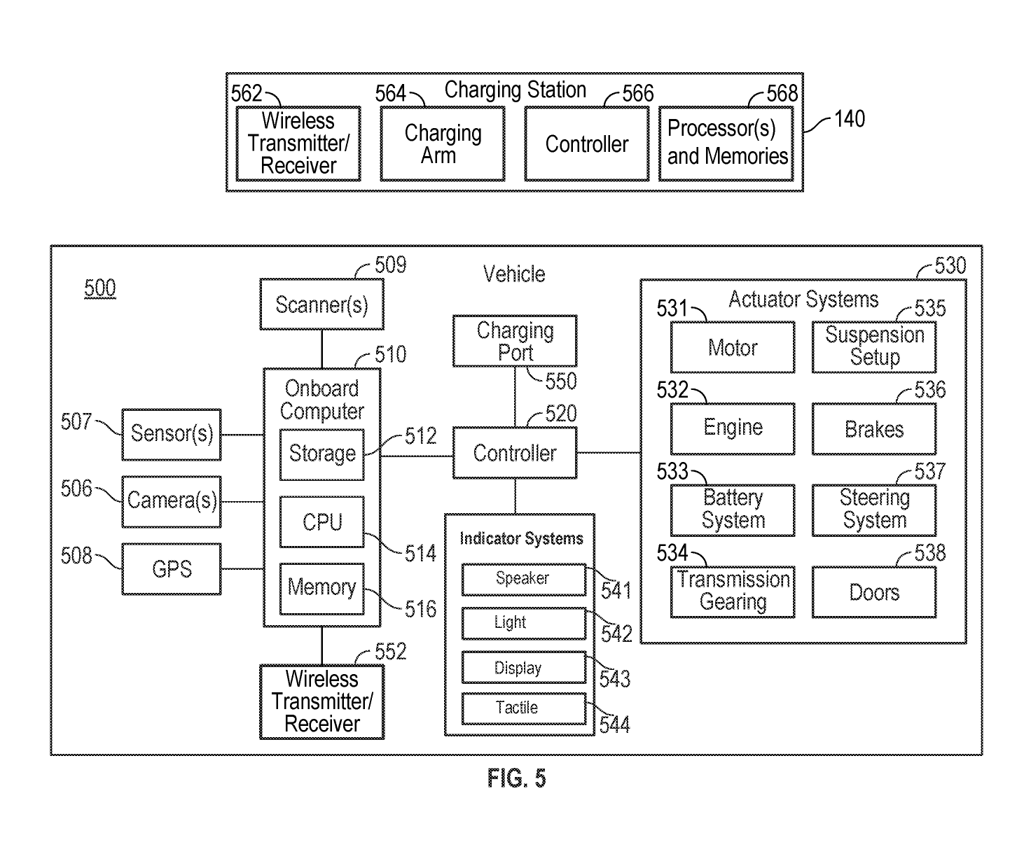

As illustrated in FIG. 1, in some examples, vehicle 110 proceeds to a parking space 130. In some examples, parking space 130 can provide access to charging station 140, which can facilitate charging of a vehicle, such as vehicle 110. In some embodiments, vehicle 110 includes a vehicle control system (e.g., system 500 shown in FIG. 5 or a portion thereof). In some examples, the vehicle control system can include one or more processors (e.g., CPUs 514), one or more scanners (e.g., scanners 509), one or more sensors (e.g., sensors 507), and one or more memories (e.g., memory 516). For instance, the vehicle control system can include one or more light detection and ranging (LiDAR) scanners for obtaining position parameters and/or orientation parameters of a charging arm of charging station 140. The vehicle control system is described in more detail below.

In some examples, the vehicle control system disposed in vehicle 110 can determine whether a charging station is available for charging. For example, the vehicle control system determines whether the vehicle is in motion; and in accordance with a determination that the vehicle is not in motion, the vehicle control system detects a charging station. As illustrated in FIG. 1, in some examples, as vehicle 110 proceeds into parking space 130, the vehicle control system determines whether vehicle 110 is still in motion using, for example, a speed sensor. If the vehicle 110 is not in motion (e.g., vehicle 110 is not moving for a pre-determined period of time), the vehicle control system determines that vehicle 110 may be safely coupled to a charging station for charging. In some examples, in accordance with a determination that vehicle 110 is not in motion (e.g., parked and/or powered off), it can detect a charging station for charging vehicle 110. For example, the vehicle control system can detect charging station 140 using a camera (e.g., an optical camera), a sensor (e.g., an ultrasonic sensor, radar sensor, or laser sensor), and/or a scanner (e.g., a LiDAR scanner). In some embodiments, the vehicle control system can detect charging station 140 based on information indicating the distribution of charging stations (e.g., an online database containing the GPS locations of charging stations near the physical location of vehicle 110).

In some embodiments, upon detecting charging station 140, the vehicle control system can determine whether charging station 140 satisfies one or more pre-configured conditions for charging. As an example, the vehicle control system can determine whether a distance between a charging arm of charging station 140 and vehicle 110 satisfies a distance condition. If the distance is within a threshold distance, the vehicle control system determines that the charging arm of charging station 140 is accessible to vehicle 110 and determines that the distance satisfies the distance condition. If the distance is greater than a threshold distance, the vehicle control system determines that the charging arm is not accessible to vehicle 110 and that the distance does not satisfy the distance condition. In some embodiments, the vehicle control system determines the distance between a charging arm of charging station 140 and vehicle 110 using a camera (e.g., an optical camera), a sensor (e.g., an ultrasonic sensor, radar sensor, or laser sensor), a GPS, and/or a scanner (e.g., a LiDAR scanner). In some examples, the distance can be obtained based on the positions of charging station 140 and vehicle 110.

As another example, the vehicle control system can determine whether an orientation of the charging station 140 with respect to vehicle 110 satisfies an orientation condition. In some examples, an orientation of the charging station 140 with respect to vehicle 110 can indicate that a charging port of vehicle 110 (e.g., a charging port that is located in the front portion of vehicle 110) is facing toward charging station 140, on the left side or right side of charging station 140, at an angle with charging station 140, facing away from charging station 140, or the like. An orientation condition includes, for example, a threshold relation (e.g., a threshold angle) between the charging port of vehicle 110 and charging station 140. For example, if the orientation is within the threshold angle, the vehicle control system determines that the charging arm of charging station 140 is accessible to vehicle 110 and the vehicle control system determines that the orientation satisfies the orientation condition. If the orientation is greater than a threshold angle, the vehicle control system determines that the charging arm of charging station 140 is not accessible to vehicle 110 and the vehicle control system determines that the orientation does not satisfy the orientation condition. In some embodiments, the vehicle control system determines the orientation of the charging station 140 with respect to vehicle 110 using a camera (e.g., an optical camera), a sensor (e.g., an ultrasonic sensor, radar sensor, laser sensor), and/or a scanner (e.g., a LiDAR scanner).

As another example, the vehicle control system can determine whether a capacity of charging station 140 satisfies a capacity condition. A capacity of charging station 140 indicates the charging capabilities of the charging station 140 and can be determined based on, for example, the maximum charging voltage, the maximum charging current, or the like. In some embodiments, the vehicle control system can determine whether the capacity of charging station 140 satisfies a capacity condition. A capacity condition indicates a threshold capacity required for charging vehicle 110. As described, vehicle 110 can be any type of vehicle that has one or more batteries. Different vehicles can have different battery capacities (e.g., 20 kWh, 40 kWh, 60 kWh, 90 kWh, or the like). As a result, the requirement for charging different vehicles with different capacities can be different. A charging station that has a small charging capacity may not be able to charge a vehicle with a large battery capacity or may not be able to complete the charging of the vehicle in an acceptable period of time. In some examples, if the capacity of charging station 140 is equal to or greater than a threshold capacity, the vehicle control system determines that the capacity satisfies the capacity condition. If the capacity of charging station 140 is less than a threshold capacity, the vehicle control system determines that the capacity does not satisfy the capacity condition. In some embodiments, the vehicle control system determines the capacity of charging station 140 using wireless communication (e.g., near-field communication (NFC)) between vehicle 110 and charging station 140. In some embodiments, the vehicle control system determines the capacity of charging station 140 using information stored internally in or externally to vehicle 110 (e.g., on a database indicating the capacity of charging stations near vehicle 110).

As another example, the vehicle control system can determine whether a type of charging station 140 correlates to a type of vehicle 110. A type of charging station 140 indicates, for example, the type of the charging arm, the type of the charging adaptor, the manufacturer of the charging stations, the charging voltage, the charging current, the type of power supply (e.g., single phase or three phase), and/or any other information associated with charging station 140. In some embodiments, the vehicle control system can determine whether the type of charging station 140 and type of vehicle 110 match with each other. In some embodiments, if the type of charging station 140 and type of vehicle 110 do not match with each other (e.g., a mismatch between the size of the charging adaptor of charging station 140 and the size of the charging port of vehicle 110), the vehicle control system determines that the charging of vehicle 110 may not be carried out or may not be completed in an acceptable period of time. In some embodiments, the vehicle control system determines the type of charging station 140 using wireless communication (e.g., NFC) between vehicle 110 and charging station 140, information stored internally in or externally to vehicle 110 (e.g., a database indicating the type of charging stations near vehicle 110), or the like.

As another example, the vehicle control system can determine whether charging vehicle 110 using charging station 140 is interfered with by an object. For example, using a camera (e.g., an optical camera), a sensor (e.g., an ultrasonic sensor, radar sensor, or laser sensor), and/or a scanner (e.g., a LiDAR scanner), the vehicle control system can detect an object (e.g., a bush, a tree, an animal, or the like) that may interfere the charging of vehicle 110 using charging station 140.

In some embodiments, in accordance with a determination that the charging station does not satisfy one or more pre-configured conditions for charging as described above, the vehicle control system can make adjustments and/or alert the user. For example, if the vehicle control system determines that that distance between vehicle 110 and charging station 140 is greater than a threshold distance such that charging station 140 is not accessible to vehicle 110, it can re-position vehicle 110 to be within the threshold distance to charging station 140. If the vehicle control system determines that charging vehicle 110 using the charging station 140 is interfered with by an object, it can alert the user to remove the object (e.g., by making a sound or sending a message to a mobile electronic device such as a smart phone).

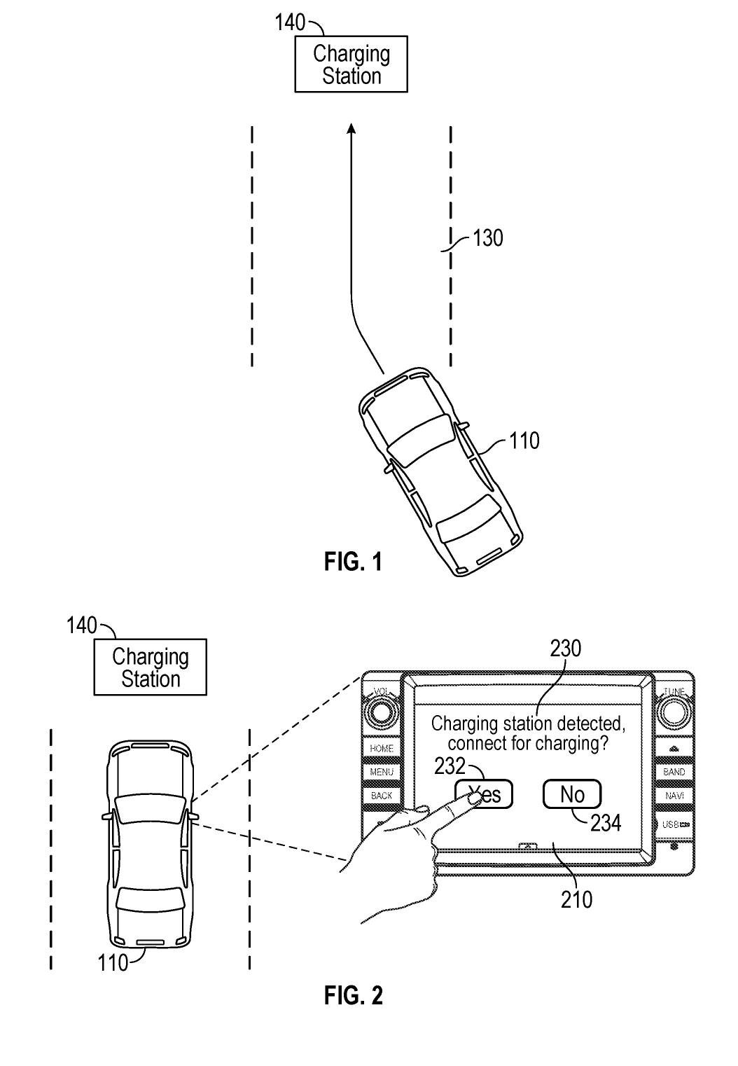

FIG. 2 illustrates an exemplary scenario in which a vehicle control system disposed in vehicle 110 determines whether charging of vehicle 110 is to be initiated according to examples of the disclosure. As described, the vehicle control system disposed in vehicle 110 can determine that charging station 140 is available to charge vehicle 110. In accordance with such a determination, in some embodiments, the vehicle control system can determine whether charging of vehicle 110 is to be initiated based on a user input. For example, the vehicle control system can provide an output 230 requesting a user input to initiate the charging of vehicle 110. As shown in FIG. 2, output 230 can include text being displayed on a display disposed in vehicle 110. Output 230 can include, for example, “Charging station detected, connect for charging?” In some embodiments, output 230 can include a spoken output that is provided to the user via an audio device disposed in vehicle 110. In some embodiments, output 230 can include one or more options (e.g., a “Yes” option 232 and a “No” option 234) that the user can select. The user can select the “Yes” option 232 if the user desires to charge vehicle 110 using charging station 140; the user can select the “No” option 234 if the user does not desire to charge vehicle 110 using charging station 140. In some embodiments, the user can provide speech input to charge or not charge vehicle 110. As shown in FIG. 2, the vehicle control system can receive the user input (e.g., selection of options 232 or 234, or a speech input) to charge or not charge vehicle 110 using charging station 140.

In some embodiments, in accordance with a determination that a charging station is available, the vehicle control system can determine whether the charging of vehicle 110 is to be initiated based on context information. In some examples, the context information can include the vehicle's historical charging data. For example, the historical charging data of vehicle 110 may indicate that the user frequently charges vehicle 110 using charging station 140. For example, charging station 140 is located at the user's home or work address, and the user charges vehicle 110 using charging station 140 at or around the same time of day. In some examples, the context information can include the battery status of vehicle 110. For example, the battery status of vehicle 110 may indicate that it is below a predetermined threshold percentage and thus vehicle 110 requires charging. Based on context information, the vehicle control system determines that charging of vehicle 110 is to be initiated with or without an additional user input. It is appreciated that ok context information can include any other type of information that the vehicle control system can use to determine whether the charging of vehicle 110 is to be initiated.

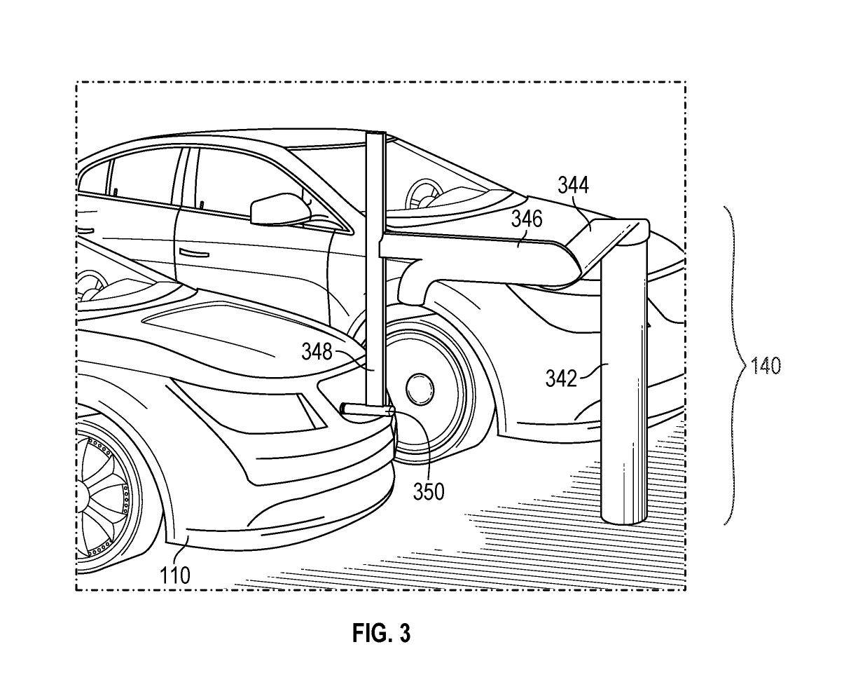

FIG. 3 illustrates an exemplary automated vehicle charging scenario in which a vehicle control system disposed in a vehicle generates one or more commands to control the motion of a charging arm of a charging station according to examples of the disclosure. As illustrated in FIG. 3, in some examples, charging station 140 includes a support structure 342 and a charging arm. The charging arm can include, for example, a first arm portion 344, a second arm portion 346, a third arm portion 348, and a charging adaptor 350. Support structure 342, first arm portion 344, second arm portion 346, and third arm portion 348 can be pivotally, hingedly, rotatably, movably, glidingly, permanently, detachably, or latchably coupled to one another to enable any number of degrees of freedom. As an example, as shown in FIG. 3, first arm portion 344 and second arm portion 346 can be pivotally and/or rotatably coupled to each other to enable horizontal motion of first arm portion 344 and/or second arm portion 346. Second arm portion 346 and third arm portion 348 can be glidingly and/or rotatably couple to each other to enable vertical and/or rotational motion of second arm portion 346 and/or third arm portion 348. It is appreciated that the charging arm can include any number of arm portions (e.g., 1, 2, 3, 4, or 5) and the arm portions can be configured in any desired shape and couple to one another using any desired connections.

In some embodiments, in accordance with a determination that a charging station is available and/or a determination that charging is to be initiated, the vehicle control system disposed in vehicle 110 can obtain one or more position parameters, using one or more scanners, for the charging arm of charging station 140. As described, the one or more scanners can include laser scanners such as LiDAR scanners. As an example, the one or more position parameters can include coordinates of the charging arm or a portion thereof (e.g., first arm portion 344, second arm portion 346, third arm portion 348, and/or charging adaptor 350). In some examples, the coordinates can include a first coordinate, a second coordinate, and a third coordinate (e.g., X, Y, and Z in a Cartesian coordinate system). In some examples, the one or more scanners detect the coordinates of the charging arm or a portion thereof in accordance with a vehicle rear axle coordinate system.

In some embodiments, the vehicle control system disposed in vehicle 110 can determine whether the charging arm conforms to a pre-configured position. For example, the charging arm of charging station 140 can have a default position when the charging arm is not coupled to a vehicle. In some examples, based on the one or more position parameters obtained, the vehicle control system can determine that the charging arm does not conform to the default position. In some examples, in accordance with a determination that the charging arm of the charging station does not conform to the pre-configured position (e.g., the default position), the vehicle control system can generate one or more re-positioning commands to control the motion of the charging arm to conform to the pre-configured position. A re-positioning command can include, for example, a reset signal to reset the charging arm to conform to its default position.

In some embodiments, in accordance with a determination that a charging station is available and/or a determination that charging is to be initiated, the vehicle control system disposed in vehicle 110 can obtain one or more orientation parameters, using one or more scanners, for the charging arm of charging station 140. As an example, the one or more orientation parameters can include parameters associated with one or more degrees of freedom of the charging arm or a portion thereof (e.g., first arm portion 344, second arm portion 346, third arm portion 348, and/or charging adaptor 350). In some examples, the degrees of freedom can include yawing (e.g., swiveling left or right), pitching (e.g., tilting forward or backward), and rolling (e.g., pivoting side to side).

In some embodiments, the vehicle control system disposed in vehicle 110 can determine whether the charging arm of charging station 140 conforms to a pre-configured orientation. For example, the charging arm of charging station 140 can have a default orientation (e.g., default yawing, pitching, and rolling) when the charging arm is not coupled to a vehicle. In some examples, based on the one or more orientation parameters obtained, the vehicle control system can determine that the charging arm does not conform to the default orientation. In some examples, in accordance with a determination that the charging arm of the charging station does not conform to the pre-configured orientation (e.g., the default orientation), the vehicle control system can generate one or more re-orientation commands to control the motion of the charging arm to conform to the pre-configured orientation. A re-orientation command can include, for example, a reset signal to reset the charging arm to conform to its default orientation.

In some embodiments, based on the one or more position parameters and/or orientation parameters, the vehicle control system can generate one or more commands to control the motion of the charging arm to couple the charging arm to the vehicle to charge the vehicle. In some examples, to generate the one or more commands, the vehicle control system disposed in vehicle 110 can obtain a pre-determined model of charging station 140. The pre-determined model can be, for example, a 3D model of charging station 140 or a similar charging station. The vehicle control system can correlate the one or more position parameters and/or orientation parameters for the charging arm of charging station 140 with the pre-determined model of charging station 140. For example, the vehicle control system can compare and obtain differences between the one or more position parameters and/or orientation parameters for the charging arm (e.g., including the charging adaptor) of charging station 140 and the 3D model of charging station 140.

In some examples, in accordance with the correlation, the vehicle control system can estimate the motion of the charging arm of charging station 140. For example, using a local motion model fitting algorithm, the vehicle control system can estimate capacity and one or more parameters of a charging arm motion model (e.g., a pose estimation). In some examples, based on the estimation, the vehicle control system can estimate the motion of the charging arm of charging station 140. For example, the vehicle control system can estimate the quantity of movement that the charging arm (e.g., including charging adaptor 350) is required to move to couple to vehicle 110.

In some embodiments, based on the estimation of the motion of the charging arm, the vehicle control system can generate one or more commands to control the motion of the charging arm to couple the charging arm to the vehicle. For example, as illustrated in FIG. 3, based on the estimation of the required quantity of movement (e.g., the X, Y, and Z movements or shifts) for the charging arm, the vehicle control system can generate one or more control commands to move charging adaptor 350 (and/or any portion of the charging arm) to couple to the charging port of vehicle 110. After the commands are generated, they can be transmitted to charging station 140 to execute. In some examples, the transmission is performed using wireless communication (e.g., a NFC connection) between vehicle 110 and charging station 140.

In some embodiments, the commands are generated and/or transmitted to iteratively control the motion of the charging arm of charging station 140. For example, the vehicle control system can generate and transmit one or more initial commands to move the charging arm, obtain the position and/or orientation parameters after the execution of the initial commands, re-correlate the parameters, and re-estimate the motion required for the next iteration, and generate and transmit additional commands to further move the charging arm of charging station 140. The vehicle control system can thus iteratively control the movements of the charging arm to couple to vehicle 110.

In some embodiments, the one or more commands generated by the vehicle control system may not control the charging arm of charging station 140 to completely couple to vehicle 110. Instead, the one or more commands can control the charging arm such that charging adaptor 350 of the charging arm aligns with a charging port of vehicle 110. After they are aligned, a coupling mechanism (e.g., a magnet-based mechanism) disposed in the charging adaptor 350 and/or the charging port of vehicle 110 can complete the coupling of the charging arm to vehicle 110.

In some embodiments, the vehicle control system can determine whether the charging station 140 is to be decoupled from vehicle 110. For example, the vehicle control system can determine that charging station 140 is to be decoupled if the charging of vehicle 110 is complete (e.g., batteries of vehicle 110 are 100% charged), charging station is no longer available to charge the vehicle (e.g., because of a power outage or an circuit overload), and/or a user input is received to decouple the charging station from the vehicle 110. For example, the user input can include an indication that the vehicle 110 is powered on for driving, a speech input or a touch input from the user to decouple the charging arm from vehicle 110, or the like.

In some examples, in accordance with a determination that the charging station is to be decoupled from the vehicle, the vehicle control system can generate a decoupling command to electrically decouple the charging arm of the charging station 140 from vehicle 110 in accordance with the decoupling command. For example, according to the determination that the charging is complete or that the user powers on vehicle 110, the vehicle control system generates and transmits a decoupling command to control the charging arm to disconnect charging adaptor 350 from the charging port of vehicle 110.

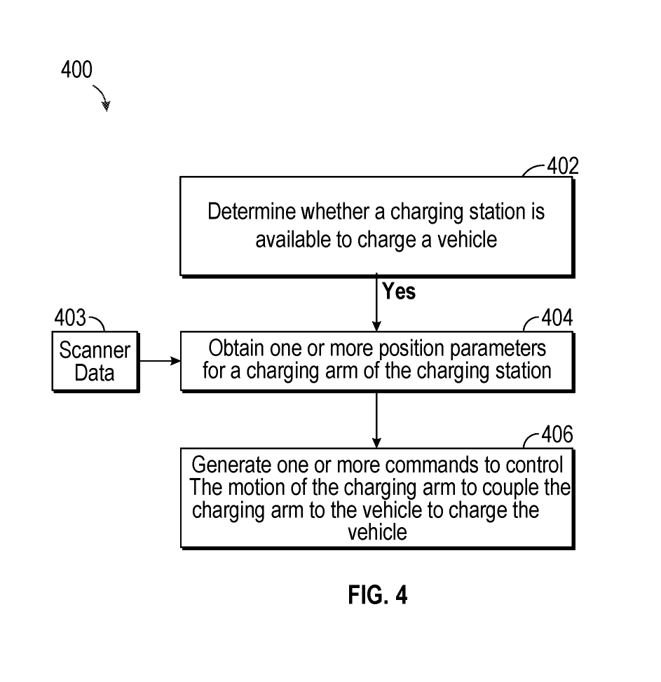

FIG. 4 illustrates an exemplary process 400 for automated vehicle charging according to examples of the disclosure. At block 402, whether a charging station is available for charging is determined (e.g., as described in FIGS. 1-3). In some examples, in determining whether a charging station is available, whether a vehicle is in motion can be determined. In accordance with a determination that the vehicle is not in motion, a charging station can be detected. Upon detecting the charging station, whether the charging station satisfies one or more pre-configured conditions for charging can be determined. For example, the pre-configured conditions can include a distance condition regarding a distance between the charging arm of the charging station and the vehicle; an orientation condition regarding an orientation of the charging station with respect to the vehicle; a capacity condition regarding a capacity of the charging station; a type condition regarding the corrections of a type of charging station with respect to the type of vehicle; and an interfering condition regarding an object that interferes with the charging of the vehicle using the charging station. In some embodiments, in accordance with a determination that the charging station satisfies one or more pre-configured conditions for charging, the charging station is determined to be available for charging.

In some examples, in accordance with a determination that a charging station is available, whether the charging of the vehicle is to be initiated can be determined based on a user input and/or context information. For example, if the user input confirms charging the vehicle and/or the context information indicates the vehicle is frequently charged using the charging station, it can be determined that charging of the vehicle is to be initiated.

At block 404, in accordance with a determination that a charging station is available and/or a determination that charging is to be initiated, one or more position parameters for a charging arm of the charging station can be obtained using one or more scanners (e.g., as described with reference to FIGS. 1-3). As an example, the one or more position parameters can include coordinates of the charging arm or a portion thereof. In some examples, the coordinates can include a first coordinate, a second coordinate, and a third coordinate (e.g., X, Y, and Z in a Cartesian coordinate system). In some examples, the one or more scanners detect the coordinates of the charging arm or a portion thereof in accordance with a vehicle rear axle coordinate system. At block 403, scanner data (e.g., coordinates) can be provided.

In some embodiments, in accordance with a determination that a charging station is available and/or a determination that charging is to be initiated, one or more orientation parameters for the charging arm of the charging station can be obtained using one or more scanners. As an example, the one or more orientation parameters can include parameters associated with one or more degrees of freedom of the charging arm or a portion thereof. In some examples, the degrees of freedom can include yawing (e.g., swiveling left or right), pitching (e.g., tilting forward or backward), and rolling (e.g., pivoting side to side).

At block 406, based on the one or more position parameters and/or orientation parameters, one or more commands can be generated to control the motion of the charging arm to couple the charging arm to the vehicle to charge the vehicle (e.g., as described with reference to FIGS. 1-3). In some examples, to generate the one or more commands, a pre-determined model (e.g., a 3D model) of a charging station can be obtained. The one or more position parameters and/or orientation parameters for the charging arm of the charging station can be correlated with the pre-determined model of the charging station. In some examples, in accordance with the correlation, the motion of the charging arm of the charging station can be estimated. For example, using a local motion model fitting algorithm, capacity and one or more parameters of a charging arm motion model can be estimated (e.g., a pose estimation). In some examples, based on the estimation, the motion of the charging arm of the charging station can be estimated. For example, the quantity of movement that the charging arm (e.g., including the charging adaptor) is required to move to couple the charging arm of the charging station to the vehicle can be estimated.

In some embodiments, based on the estimation, one or more commands can be generated to control the motion of the charging arm to couple the charging arm to the vehicle. For example, based on the estimation of the required quantity of movement (e.g., the X, Y, and Z movements or shifts) for the charging arm, control commands for moving the charging adaptor (and/or any portion of the charging arm) to couple to the charging port of the vehicle can be generated. After the commands are generated, they can be transmitted to the charging station to execute. In some embodiments, the commands are generated and/or transmitted to iteratively or progressively control the motion of the charging arm of the charging station to couple to the vehicle.

FIG. 5 illustrates a system block diagram of an exemplary vehicle control system 500 and an exemplary charging station 140 according to examples of the disclosure. Vehicle control system 500 can perform any of the methods described with reference to FIGS. 1-3. System 500 can be incorporated into a vehicle, such as an electronic vehicle, an autonomous vehicle, or the like. Other example vehicles that may incorporate the system 500 include, without limitation, airplanes, boats, or industrial automobiles.

System 500 can include one or more cameras 506 capable of capturing image data (e.g., video data), as previously described with respect to FIGS. 1-3. Vehicle control system 500 can also include one or more other sensors 507 (e.g., radar or ultrasonic sensors) and scanners 509 (e.g., LiDAR scanners) capable of detecting objects in the vehicle's surroundings. Vehicle control system 500 can include an on-board computer 510 coupled to the cameras 506, sensors 507, and scanners 509. Vehicle control system 500 can also include a global positioning system (GPS) 508 capable of determining the position of the vehicle and/or any other positions. On-board computer 510 can be capable of receiving the image data from the camera, outputs from the sensors 507, GPS 508, and/or scanners 509. The on-board computer 510 can be capable of, for example, determining whether a charging station is available to charge the vehicle, obtaining position parameters, and generating commands to control the motion of the charging arm to couple the charging arm to the vehicle to charge the vehicle, as described in this disclosure. On-board computer 510 can include storage 512, memory 516, and a processor 514. Processor 514 can perform any of the methods described with reference to FIGS. 1-4. Additionally, storage 512 and/or memory 516 can store data and instructions for performing any of the methods described with reference to FIGS. 1-4. Storage 512 and/or memory 516 can be any non-transitory computer readable storage medium, such as a solid-state drive or a hard disk drive, among other possibilities. The vehicle control system 500 can also include a controller 520 capable of controlling one or more aspects of vehicle operation, such as providing an indication to a driver based on the determinations of the on-board computer 510.

In some examples, the vehicle control system 500 can be connected to (e.g., via controller 520) one or more actuator systems 530 in the vehicle and one or more indicator systems 540 in the vehicle. The one or more actuator systems 530 can include, but are not limited to, a motor 531 or engine 532, battery system 533, transmission gearing 534, suspension setup 535, brakes 536, steering system 537, and door system 538. The vehicle control system 500 can control, via controller 520, one or more of these actuator systems 530 during vehicle operation. The one or more indicator systems 540 can include, but are not limited to, one or more speakers 541 in the vehicle (e.g., as part of an entertainment system and/or navigation system in the vehicle), one or more lights 542 in the vehicle, one or more displays 543 in the vehicle (e.g., as part of a control or entertainment system and/or navigation system in the vehicle) and one or more tactile actuators 544 in the vehicle (e.g., as part of a steering wheel or seat in the vehicle). The vehicle control system 500 can control, via controller 520, one or more of these indicator systems 540 to provide indications to the driver of information related to detecting and coupling to a charging station, charging status of the vehicle, and/or decoupling from the charging station. This can be done as described with reference to FIGS. 1-3, for example.

In some examples, the vehicle control system 500 can include a charging port capable of coupling to a charging arm of a charging station, and a wireless transmitter/receiver 552 capable of communicating with the charging station. For example, the vehicle control system 500 can control, via controller 520, the charging port 550 to electrically couple and receive electrical charges from the charging station. In some examples, vehicle control system 500 can communicate commands generated by on-board computer 510 to the charging station.

FIG. 5 also illustrates a charging station 140. Charging station 140 can include, for example, a charging arm 564, a controller 566, one or more processors and memories 568, and wireless transmitter/receiver 562. In some examples, charging station 140 can receive, via wireless transmitter/receiver 562, one or more commands from vehicle control system 500. In some examples, charging station 140 can process the commands via processors and memories 568. In some examples, charging station 140 can control, via controller 566, the charging arm 564 to couple to the vehicle. This can be done as described with reference to FIGS. 1-3, for example.

Thus, the examples of the disclosure describe various ways to perform automated charging of a vehicle using a charging station.

Therefore, according to the above, some examples of the disclosure are directed to a system comprising: one or more processors; one or more scanners; and one or more memories, the one or more memories including instructions, which when executed by the one or more processors, cause the one or more processors to perform a method comprising: determining whether a charging station is available to charge the vehicle; in accordance with a determination that a charging station is available, obtaining one or more position parameters, using the one or more scanners, for a charging arm of the charging station; and generating one or more commands, based on the obtained one or more position parameters, to control the motion of the charging arm to couple the charging arm to the vehicle to charge the vehicle. Additionally or alternatively to one or more of the examples disclosed above, in some examples, the one or more scanners disposed in the vehicle include light detection and ranging (LiDAR) scanners. Additionally or alternatively to one or more of the examples disclosed above, in some examples, determining whether the charging station is available to charge the vehicle includes determining whether the vehicle is in motion; in accordance with a determination that the vehicle is not in motion, detecting the charging station; and upon detecting the charging station, determining whether the charging station satisfies one or more pre-configured conditions for charging.

Additionally or alternatively to one or more of the examples disclosed above, in some examples, detecting the charging station includes sensing the charging station using one or more sensors disposed in the vehicle. Additionally or alternatively to one or more of the examples disclosed above, in some examples, determining whether the charging station satisfies one or more pre-configured conditions for charging includes determining at least one of: whether a distance between the charging arm of the charging station and the vehicle satisfies a distance condition; whether an orientation of the charging station with respect to the vehicle satisfies an orientation condition; whether a capacity of the charging station satisfies a capacity condition; whether a type of the charging station correlates to a type of the vehicle; and whether charging the vehicle using the charging station is interfered with by an object.

Additionally or alternatively to one or more of the examples disclosed above, in some examples, the method further includes, prior to obtaining the one or more position parameters for the charging arm of the charging station: determining whether charging the vehicle is to be initiated based on at least one of a user input to charge the vehicle or context information; and in accordance with a determination that charging of the vehicle is to be initiated, obtaining the one or more position parameters.

Additionally or alternatively to one or more of the examples disclosed above, in some examples, the method further includes, prior to generating one or more commands to control the motion of the charging arm to couple the charging arm to the vehicle to charge the vehicle: determining whether the charging arm of the charging station conforms to a pre-configured position; and in accordance with a determination that the charging arm of the charging station does not conform to the pre-configured position, generating one or more re-positioning commands to control the motion of the charging arm to conform to the pre-configured position.

Additionally or alternatively to one or more of the examples disclosed above, in some examples, the method further includes, obtaining one or more orientation parameters, using the one or more scanners disposed in the vehicle, for the charging arm of the charging station. Additionally or alternatively to one or more of the examples disclosed above, in some examples, the method further comprises, prior to generating one or more commands to control the motion of the charging arm to couple the charging arm to the vehicle to charge the vehicle: determining whether the charging arm of the charging station conforms to a pre-configured orientation; and in accordance with a determination that the charging arm of the charging station does not conform to the pre-configured orientation, generating one or more re-orienting commands to control the motion of the charging arm to conform to the pre-configured orientation.

Additionally or alternatively to one or more of the examples disclosed above, in some examples, the one or more position parameters for a charging arm of the charging station include a first coordinate, a second coordinate, and a third coordinate. Additionally or alternatively to one or more of the examples disclosed above, in some examples, the charging arm includes a charging adaptor to couple the charging arm to the vehicle. Additionally or alternatively to one or more of the examples disclosed above, in some examples, generating one or more commands, based on the one or more position parameters, to control the motion of the charging arm to couple the charging arm to the vehicle to charge the vehicle includes: obtaining a pre-determined model of the charging station; correlating the one or more position parameters for the charging arm of the charging station with the pre-determined model of the charging station; in accordance with the correlation, estimating the motion of the charging arm of the charging station; and generating the one or more commands based on the estimation of the motion.

Additionally or alternatively to one or more of the examples disclosed above, in some examples, the pre-determined model is a 3D model. Additionally or alternatively to one or more of the examples disclosed above, in some examples, estimating the motion of the charging arm of the charging station is based on a local motion model fitting algorithm. Additionally or alternatively to one or more of the examples disclosed above, in some examples, generating the one or more commands is further based on one or more orientation parameters of the charging arm of the charging station. Additionally or alternatively to one or more of the examples disclosed above, in some examples, the method further includes transmitting the one or more commands to the charging station, wherein the one or more commands control the motion of a charging adaptor of the charging arm to align with a charging port of the vehicle. Additionally or alternatively to one or more of the examples disclosed above, in some examples, the method further includes determining whether the charging station is to be decoupled from the vehicle; and in accordance with a determination that the charging station is to be decoupled from the vehicle: generating a decoupling command to electrically decouple the charging arm of the charging station from the vehicle in accordance with the decoupling command.

Additionally or alternatively to one or more of the examples disclosed above, in some examples, the determination that the charging station is to be decoupled from the vehicle includes at least one of: a determination that charging of the vehicle is complete; a determination that the charging station is no longer available to charge the vehicle; and a determination that a user input is received to decouple the charging station from the vehicle.

Some examples of the disclosure are directed to a non-transitory computer-readable medium including instructions stored in one or more memories disposed in a vehicle, which, when executed by one or more processors disposed in the vehicle, cause the one or more processors to perform a method comprising: determining whether a charging station is available to charge a vehicle; in accordance with a determination that a charging station is available, obtaining one or more position parameters, using one or more scanners disposed in the vehicle, for a charging arm of the charging station; and generating one or more commands, based on the obtained one or more position parameters, to control the motion of the charging arm to couple the charging arm to the vehicle to charge the vehicle.

Some examples of the disclosure are directed to a vehicle comprising: one or more scanners; one or more processors; and one or more memories, the one or more memories including instructions, which when executed by the one or more processors, cause the one or more processors to perform a method comprising: determining whether a charging station is available to charge a vehicle; in accordance with a determination that a charging station is available, obtaining one or more position parameters, using the one or more scanners disposed in the vehicle, for a charging arm of the charging station; and generating one or more commands, based on the obtained one or more position parameters, to control the motion of the charging arm to couple the charging arm to the vehicle to charge the vehicle.

Although examples of this disclosure have been fully described with reference to the accompanying drawings, it is to be noted that various changes and modifications will become apparent to those skilled in the art. Such changes and modifications are to be understood as being included within the scope of examples of this disclosure as defined by the appended claims.

1. A system for charging a vehicle, the system being disposed or included in the vehicle, comprising:
one or more processors;
one or more scanners; and
one or more memories, the one or more memories including instructions, which when executed by the one or more processors, cause the one or more processors to perform a method comprising:
determining whether a charging station is available to charge the vehicle;
in accordance with a determination that a charging station is available, obtaining one or more position parameters, using the one or more scanners, for a charging arm of the charging station; and
generating one or more commands, based on the obtained one or more position parameters, to control the motion of the charging arm to couple the charging arm to the vehicle to charge the vehicle.

2. The system of claim 1, wherein the one or more scanners disposed in the vehicle include light detection and ranging (LiDAR) scanners.

3. The system of claim 1, wherein determining whether the charging station is available to charge the vehicle comprises:
determining whether the vehicle is in motion;
in accordance with a determination that the vehicle is not in motion, detecting the charging station; and
upon detecting the charging station, determining whether the charging station satisfies one or more pre-configured conditions for charging.

4. The system of claim 3, wherein detecting the charging station comprises sensing the charging station using one or more sensors disposed in the vehicle.

5. The system of claim 3, wherein determining whether the charging station satisfies one or more pre-configured conditions for charging comprises determining at least one of:
whether a distance between the charging arm of the charging station and the vehicle satisfies a distance condition;
whether an orientation of the charging station with respect to the vehicle satisfies an orientation condition;
whether a capacity of the charging station satisfies a capacity condition;
whether a type of the charging station correlates to a type of the vehicle; and
whether charging the vehicle using the charging station is interfered with by an object.

6. The system of claim 1, wherein the method further comprising, prior to obtaining the one or more position parameters for the charging arm of the charging station:
determining whether charging the vehicle is to be initiated based on at least one of a user input to charge the vehicle or context information; and
in accordance with a determination that charging of the vehicle is to be initiated, obtaining the one or more position parameters.

7. The system of claim 1, wherein the method further comprises, prior to generating one or more commands to control the motion of the charging arm to couple the charging arm to the vehicle to charge the vehicle:
determining whether the charging arm of the charging station conforms to a pre-configured position; and
in accordance with a determination that the charging arm of the charging station does not conform to the pre-configured position, generating one or more re-positioning commands to control the motion of the charging arm to conform to the pre-configured position.

8. The system of claim 1, wherein the method further comprises, obtaining one or more orientation parameters, using the one or more scanners disposed in the vehicle, for the charging arm of the charging station.

9. The system of claim 8, wherein the method further comprises, prior to generating one or more commands to control the motion of the charging arm to couple the charging arm to the vehicle to charge the vehicle:
determining whether the charging arm of the charging station conforms to a pre-configured orientation; and
in accordance with a determination that the charging arm of the charging station does not conform to the pre-configured orientation, generating one or more re-orienting commands to control the motion of the charging arm to conform to the pre-configured orientation.

10. The system of claim 1, wherein the one or more position parameters for a charging arm of the charging station comprise a first coordinate, a second coordinate, and a third coordinate.

11. The system of claim 1, wherein the charging arm includes a charging adaptor to couple the charging arm to the vehicle.

12. The system of claim 1, wherein generating one or more commands, based on the one or more position parameters, to control the motion of the charging arm to couple the charging arm to the vehicle to charge the vehicle comprises:
obtaining a pre-determined model of the charging station;
correlating the one or more position parameters for the charging arm of the charging station with the pre-determined model of the charging station;
in accordance with the correlation, estimating the motion of the charging arm of the charging station; and
generating the one or more commands based on the estimation of the motion.

13. The system of claim 12, wherein the pre-determined model is a 3D model.

14. The system of claim 12, wherein estimating the motion of the charging arm of the charging station is based on a local motion model fitting algorithm.

15. The system of claim 1, wherein generating the one or more commands is further based on one or more orientation parameters of the charging arm of the charging station.

16. The system of claim 1, wherein the method further comprises transmitting the one or more commands to the charging station, wherein the one or more commands control the motion of a charging adaptor of the charging arm to align with a charging port of the vehicle.

17. The system of claim 1, wherein the method further comprises:
determining whether the charging station is to be decoupled from the vehicle; and
in accordance with a determination that the charging station is to be decoupled from the vehicle:
generating a decoupling command to electrically decouple the charging arm of the charging station from the vehicle in accordance with the decoupling command.

18. The system of claim 17, wherein the determination that the charging station is to be decoupled from the vehicle comprises at least one of:
a determination that charging of the vehicle is complete;
a determination that the charging station is no longer available to charge the vehicle; and
a determination that a user input is received to decouple the charging station from the vehicle.

19. A non-transitory computer-readable medium including instructions stored in one or more memories disposed in a vehicle, which when executed by one or more processors disposed in the vehicle, cause the one or more processors to perform a method comprising:
determining whether a charging station is available to charge a vehicle;
in accordance with a determination that a charging station is available, obtaining one or more position parameters, using one or more scanners disposed in the vehicle, for a charging arm of the charging station; and
generating one or more commands, based on the obtained one or more position parameters, to control the motion of the charging arm to couple the charging arm to the vehicle to charge the vehicle.

20. A vehicle comprising:
one or more scanners;
one or more processors; and
one or more memories, the one or more memories including instructions, which when executed by the one or more processors, cause the one or more processors to perform a method comprising:
determining whether a charging station is available to charge a vehicle;
in accordance with a determination that a charging station is available, obtaining one or more position parameters, using the one or more scanners disposed in the vehicle, for a charging arm of the charging station; and
generating one or more commands, based on the obtained one or more position parameters, to control the motion of the charging arm to couple the charging arm to the vehicle to charge the vehicle.
